(19) United States
(12) Patent Application Publication
(10) Pub. No.: US 2009/0064234 A1
(43) Pub. Date: Mar. 5, 2009

(54) PROGRAM RESERVATION APPARATUS AND PROGRAM RESERVATION METHOD

(75) Inventor: Shingo IKEDA, Fukaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/194,277

(22) Filed: Aug. 19, 2008

(30) Foreign Application Priority Data
Aug. 30, 2007 (JP) 2007-224368

(51) Int. Cl. G06F 13/00; H04N 7/173; H04N 5/445

(52) U.S. Cl. 725/58; 725/110; 725/39

(57) ABSTRACT

According to one embodiment a program reservation apparatus is provided with an acquiring unit for acquiring program information, a program listing producing unit for producing an electronic program listing based upon the program information acquired, a display unit for displaying the electronic program listing produced on a screen, a selecting unit for selecting and determining a desired program from the electronic program listing displayed, an e-mail producing unit for producing an e-mail main text for program reservation for making program reservation by e-mail with respect to the program selected and determined, and transmitting units for transmitting the e-mail main text for program reservation produced to the outside.

### CROSS-REFERENCE TO RELATED APPLICATIONS

This application is based upon and claims the benefit of priority from Japanese Patent Application No. 2007-224368, filed Aug. 30, 2007, the entire contents of which are incorporated herein by reference.

### BACKGROUND

1. Field

One embodiment of the invention relates to improvement of a program reservation apparatus and a program reservation method for causing a receiving apparatus which receives a provided program to make program reservation by using an e-mail function from an information terminal such as a mobile phone.

2. Description of the Related Art

As is well known, recently, digitalization of television broadcasting has been promoted. For example, in Japan, not only satellite digital broadcasting, such as BS (broadcasting satellite) digital broadcasting or 110-degree CS (communication satellite) digital broadcasting, but also terrestrial digital broadcasting has been started.

In such a digital broadcasting receiving apparatus which receives digital television broadcasts, an electronic program listing is produced based upon an EPG (electronic program guide) information acquired from a broadcast signal and displayed as an image on a screen. Thereby, a user can select a desired program from the electronic program listing displayed as an image, and watch the program or make reservation of the program.

Further, as a digital broadcasting receiving apparatus of this type, there is one equipped with a function allowing the apparatus to be connected to a network such as the Internet. Then, through the network, searching and browsing of various kinds of commercial contents updating of software of the receiving apparatus itself, and the like can be performed.

In particular, in a digital broadcasting receiving apparatus equipped with such a network connecting function, one equipped with a program reservation function using e-mail has been developed. Thereby, a user can make program reservation registration by sending an e-mail to a digital broadcasting receiving apparatus of his/her home using an information terminal such as a mobile phone, even if he/she is at a remote location.

Incidentally, presently, in order to make program reservation utilizing e-mail, a user is required to input to an information terminal an e-mail main text for program reservation in a format preset corresponding to a digital broadcasting receiving apparatus which makes a program reservation registration, namely, a digital broadcasting receiving apparatus which is the destination of the e-mail, and transmit the e-mail main text for program reservation to the digital broadcasting receiving apparatus.

However, when the e-mail main text for program reservation is input into the information terminal, the operation becomes complicated because of many input items, and since a user is required to memorize the format, namely, listing order, a keyword for specifying a channel and a digital broadcasting receiving apparatus, or the like, or carry a memo thereof, it is inconvenient for a user to use it in its current state.

Jpn. Pat. Appln. KOKAI Publication No. 2005-286762 discloses a constitution in which, when either one of broadcast schedule information items displayed on a scheduler is selected by the user's operation, record request information for specifying a selected broadcast program is transmitted to a service dedicated server by e-mail, and the service dedicated server analyzes record request information to drive a recording apparatus.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a diagram shown for schematically explaining a digital television broadcasting receiving apparatus and one example of a network system configured centering thereon according to one embodiment of the present invention;

FIG. 2 is a block configuration diagram shown for explaining a main signal processing system of the digital television broadcasting receiving apparatus according to the embodiment;

FIG. 3 is an appearance view shown for explaining a remote controller of the digital television broadcasting receiving apparatus according to the embodiment;

FIG. 4 is a diagram shown for explaining one example of an electron program listing displayed by the digital television broadcasting receiving apparatus according to the embodiment;

FIG. 5 is a diagram shown for explaining one example of a reservation selection screen displayed by the digital television broadcasting receiving apparatus according to the embodiment;

FIG. 6 is a diagram shown for explaining one example of a maker selection screen displayed by the digital television broadcasting receiving apparatus according to the embodiment;

FIG. 7 is a diagram shown for explaining one example of a model selection screen displayed by the digital television broadcasting receiving apparatus according to the embodiment;

FIG. 8 is a diagram shown for explaining one example of a conversion type selection screen displayed by the digital television broadcasting receiving apparatus according to the embodiment;

FIG. 9 is a diagram shown for explaining one example of an e-mail data communication screen displayed by the digital television broadcasting receiving apparatus according to the embodiment;

FIG. 10 is a diagram shown for explaining one example of an e-mail data transmission screen displayed by the digital television broadcasting receiving apparatus according to the embodiment;

FIG. 11 is a diagram shown for explaining one example of a data transmission completion screen displayed by the digital television broadcasting receiving apparatus according to the embodiment;

FIG. 12 is a diagram shown for explaining one example of a barcode screen displayed by the digital television broadcasting receiving apparatus according to the embodiment;

FIG. 13 is a diagram shown for explaining one example of an e-mail main text for program reservation produced by the digital television broadcasting receiving apparatus according to the embodiment;

FIG. 14 is a diagram shown for explaining another example of the e-mail main text for program reservation produced by the digital television broadcasting receiving apparatus according to the embodiment; and

FIG. 15 is a flowchart shown for explaining a main processing operation performed by the digital television broadcasting receiving apparatus according to the embodiment.

### DETAILED DESCRIPTION

Various embodiments according to the invention will be described hereinafter with reference to the accompanying drawings. In general, according to one embodiment of the invention, a program reservation apparatus is provided with an acquiring unit for acquiring program information, a program listing producing unit for producing an electronic program listing based upon the program information acquired, a display unit for displaying the electronic program listing produced on a screen, a selecting unit for selecting and determining a desired program from the electronic program listing displayed, an e-mail producing unit for producing an e-mail main text for program reservation for making program reservation by e-mail with respect to the program selected and determined, and transmitting units for transmitting the e-mail main text for program reservation produced to the outside.

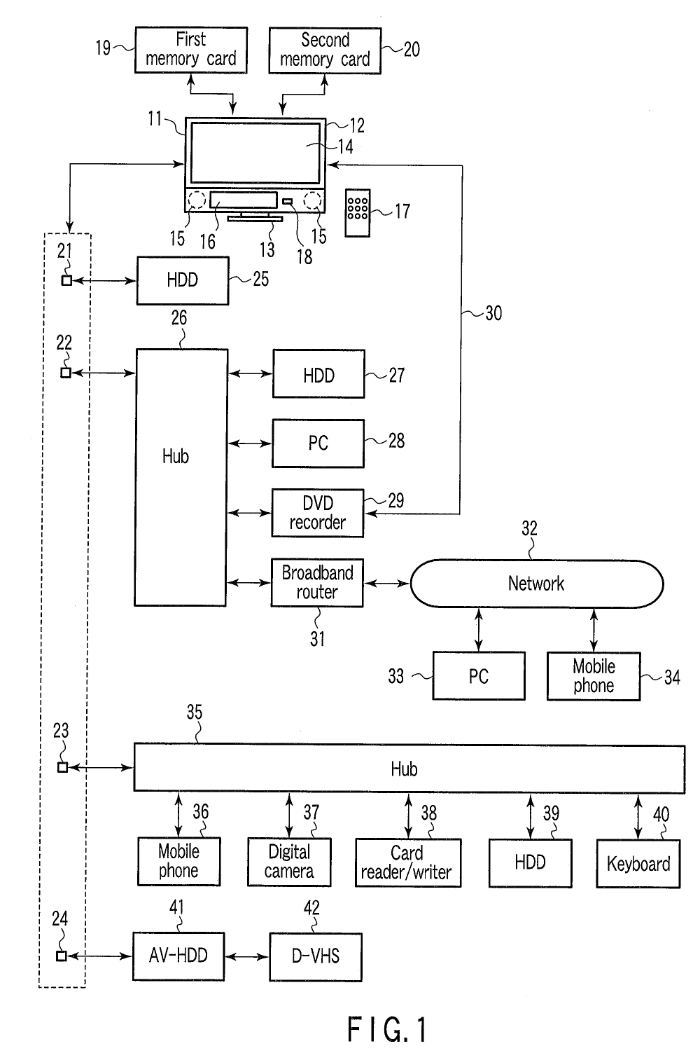

Hereinafter, one embodiment of the present invention will be explained in detail with reference to the drawings. FIG. 1 schematically shows an appearance of a digital broadcasting receiving apparatus 11 explained in the embodiment and one example of a network system configured centering on the digital television broadcasting receiving apparatus 11.

That is, the digital television broadcasting receiving apparatus 11 mainly comprises a thin cabinet 12, and a supporting stand 13 supporting the cabinet 12 in a standing manner. The cabinet 12 is provided with a video display device 14 which is a flat-panel display equipped with, for example, a liquid crystal display panel, a pair of speakers 15, an operating unit 16, a light-receiving unit 18 which receives operation information transmitted from a remote controller 17, and the like.

Further, to the digital television broadcasting receiving apparatus 11, a first memory card 19 such as an SD (secure digital) memory card, an MMC (multimedia card), and a memory stick is attachable and detachable, where recording and reproduction of information such as a program or a photograph are performed to the first memory card 19.

Further, to the digital television broadcasting receiving apparatus 11, a second memory card [IC (integrated circuit) card] 20 in which, for example, contract information or the like has been recorded is attachable and detachable. Reproduction of the contract information is performed to the second memory card 20.

Further, the digital television broadcasting receiving apparatus 11 is provided with a first LAN (local area network) terminal 21, a second LAN terminal 22, a USB (universal serial bus) terminal 23, and an IEEE (institute of electrical and electronics engineers) 1394 terminal 24.

Among them, the first LAN terminal 21 is used as a LAN-compliant HDD dedicated port for performing record and reproduction of information to a LAN-compliant HDD (hard disk drive) 25 which is a connected NAS (network attached storage) utilizing Ethernet (registered trademark).

As above, since the first LAN terminal 21 serving as a LAN-compliant HDD dedicated port is provided, information recording of a program with high-vision image quality can be performed stably to the HDD 25 without being influenced by another network environment, status of use of a network, and the like.

Further, the second LAN terminal 22 is used as a general LAN-compliant port using Ethernet (registered trademark) for connecting devices such as a LAN-compliant HDD 27, a PC (personal computer) 28, a DVD (digital versatile disk) recorder 29 with a built-in HDD having a digital broadcasting receiving function through, for example, a hub 26 to perform information transmission with these devices.

Incidentally, as for the DVD recorder 29, since digital information transmitted through the second LAN terminal 22 is only control system information, it is necessary to provide a dedicated analog transmission path 30 in order to transmit analog video and audio information between the DVD recorder 29 and the digital television broadcasting receiving apparatus 11.

Further, the second LAN terminal 22 can be connected to a network 32, such as the Internet, through a broadband router 31 connected to the hub 26, to perform information transmission with various types of information terminals, such as a PC 33 or a mobile phone 34, through the network 32.

Further, the above USB terminal 23 is used as a general USB-compliant port to connect a USB device such as a mobile phone 36, a digital camera 37, a card reader/writer 38 to a memory card, a HDD 39, or a keyboard 40 through a hub 35 to perform information transmission with these USB devices.

Further, the above IEEE 1394 terminal 24 is used to serially connect, for example, an AV (audio video)-HDD 41, a D (digital)-VHS (video home system) 42, and the like, each of which has a digital broadcasting receiving function, to perform information transmission with these devices.

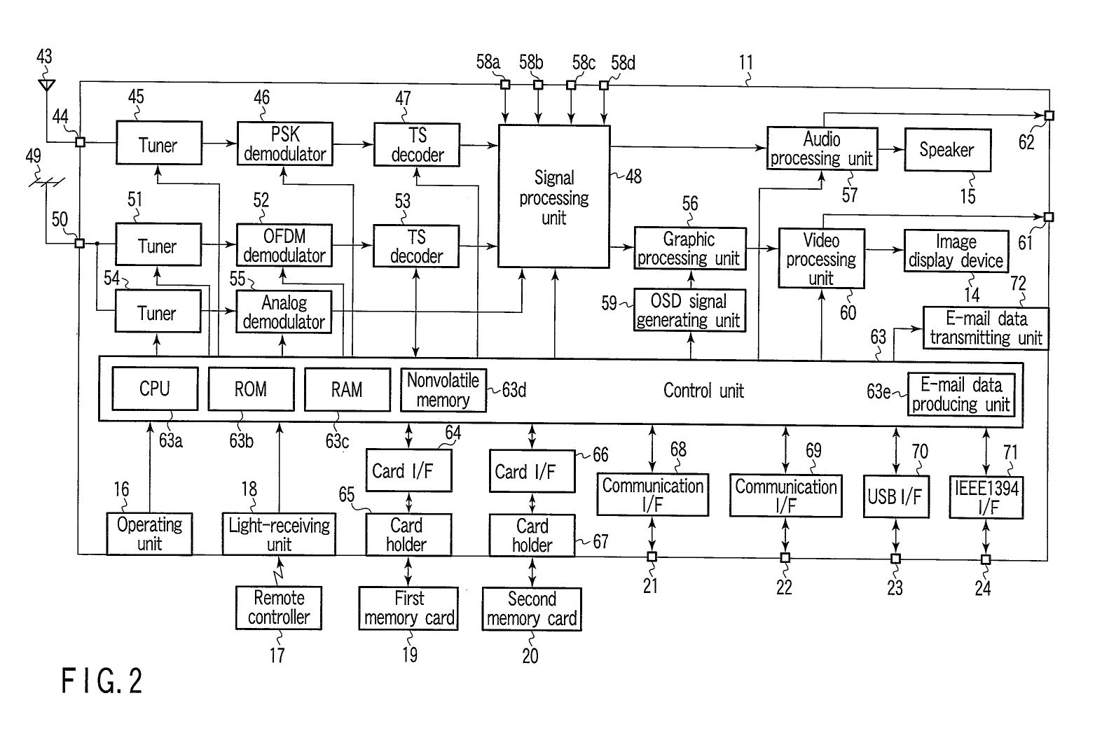

FIG. 2 shows a main signal processing system of the digital television broadcasting receiving apparatus 11. That is, satellite digital broadcasting signals received by an antenna 43 for BS/CS digital broadcasting reception are supplied to a tuner 45 for satellite digital broadcasting through an input terminal 44 so that a broadcast signal of a desired channel is selected.

Then, the broadcast signal selected by the tuner 45 is supplied to a PSK (phase shift keying) demodulator 46 to demodulate a TS (transport stream). The TS is supplied to a TS decoder 47 and decoded into a digital video signal, a digital audio signal, and the like, and then, output to a signal processing unit 48.

Further, terrestrial digital television broadcasting signals received by an antenna 49 for terrestrial broadcasting reception are supplied to a tuner 51 for terrestrial digital broadcasting through an input terminal 50, so that a broadcast signal of a desired channel is selected.

Then, the broadcasting signal selected by the tuner 51 is supplied to an OFDM (orthogonal frequency division multiplexing) demodulator 52 to demodulate a TS. The TS is supplied to a TS decoder 53 and decoded into a digital video signal, a digital audio signal, and the like, and then, output to the signal processing unit 48.

Further, a terrestrial analog television broadcasting signal received by an antenna 49 for the terrestrial broadcasting reception is supplied to a tuner 54 for terrestrial analog broadcasting through the input terminal 50, so that a broadcast signal of a desired channel is selected. Then, the broadcasting signal selected by the tuner 54 is supplied to an analog demodulator 55 and demodulated into an analog video signal and an analog audio signal, and then, output to the signal processing unit 48.

Here, the signal processing unit 48 selectively applies a predetermined digital signal processing to a digital video signal and a digital audio signal supplied from the TS decoders 47 and 53, respectively, and outputs them to a graphics processing unit 56 and an audio processing unit 57.

Further, a plurality (four in FIG. 2) of input terminals 58a, 58b, 58c, and 58d are connected to the signal processing unit 48. These input terminals 58a to 58d allow an analog video signal and an analog audio signal to be input from outside the digital television broadcasting receiving apparatus 11.

Then, the signal processing unit 48 selectively digitalizes the analog video signal and the analog audio signal supplied from the analog demodulator 55 and the respective input terminals 58a to 58d, and applies a predetermined digital signal processing to the digitalized video signal and the digitalized audio signal, and then, outputs them to the graphics processing unit 56 and the audio processing unit 57.

Among them, the graphics processing unit 56 has a function of superimposing an OSD signal generated at an OSD (on screen display) signal generating unit 59 onto the digital video signal supplied from the signal processing unit 48 and outputting it. Further, the graphics processing unit 56 can selectively output an output video signal of the signal processing unit 48 and an output OSD signal of the OSD signal generating unit 59, or can output both outputs in combination with each other such that the respective outputs configure corresponding halves of a screen.

Then, the digital video signal output from the graphics processing unit 56 is supplied to a video processing unit 60. The video processing unit 60 converts the input digital video signal into an analog video signal in a format which can be displayed by the video display device 14, and then, outputs the signal to the video display device 14 and displays it as video, and derives it to the outside through an output terminal 61.

Further, the audio processing unit 57 converts the input digital audio signal into an analog audio signal in a format which can be reproduced at the speakers 15, and then, outputs it to the speakers 15 and reproduce it as audio, and derives it to the outside through an output terminal 62.

Here, all operations, including various types of receiving operations describe above, of the digital television broadcasting receiving apparatus 11 are collectively controlled by a control unit 63. The control unit 63 incorporates a CPU (central processing unit) 63a, and receives operation information from the operating unit 16, or receives operation information delivered from the remote controller 17 and received by the light-receiving unit 18 to control the respective units such that the operation content thereof is reflected.

In this case, the control unit 63 mainly utilizes a ROM (read only memory) 63b storing therein a control program executed by the CPU 63a, a RAM (random access memory) 63c which provides a work area to the CPU 63a, and a nonvolatile memory 63d in which various types of setting information, control information, and the like are stored.

Further, the control unit 63 is connected to a card holder 65, to which the first memory card 19 is attachable, through a card I/F (interface) 64. Thereby, the control unit 63 can perform information transmission with the first memory card 19 attached to the card holder 65 through the card I/F 64.

Further, the control unit 63 is connected to a card holder 67, to which the second memory card 20 is attachable, through a card I/F (interface) 66. Thereby, the control unit 63 can perform information transmission with the second memory card 20 attached to the card holder 67 through the card I/F 66.

Further, the control unit 63 is connected to the first LAN terminal 21 through a communication I/F 68. Thereby, the control unit 63 can perform information transmission with the LAN-compliant HDD 25 connected to the first LAN terminal 21 through the communication I/F 68. In this case, the control unit 63 has a DHCP (dynamic host configuration protocol) server function, and assigns an IP (internet protocol) address to the LAN-compliant HDD 25 connected to the first LAN terminal 21 that is controlled.

Further, the control unit 63 is connected to the second LAN terminal 22 through a communication I/F 69. Thereby, the control unit 63 can perform information transmission with the respective devices (see FIG. 1) connected to the second LAN terminal 22 through the communication I/F 69.

Further, the control unit 63 is connected to the USB terminal 23 through a USB I/F 70. Thereby, the control unit 63 can perform information transmission with the respective devices (see FIG. 1) connected to the USB terminal 23 through the USB I/F 70.

Further, the control unit 63 is connected to the IEEE 1394 terminal 24 through an IEEE 1394 I/F 71. Thereby, the control unit 63 can perform information transmission with the respective devices (see FIG. 1) connected to the IEEE 1394 terminal 24 through the IEEE 1394 I/F 71.

Further, the control unit 63 includes an e-mail data producing unit 63e. The e-mail data producing unit 63e has a function of automatically producing an e-mail main text for program reservation in a format corresponding to a predetermined receiving apparatus (not shown) in order to make program reservation registration of a program selected from the electronic program listing displayed on the image display device 14 by e-mail to the receiving apparatus, the details of which will be described later.

Then, the user transmits the e-mail main text for program reservation produced at the e-mail data producing unit 63e to the receiving apparatus which makes program reservation registration by wireless transmission through an e-mail data transmitting unit 72 to an information terminal (not shown) for transmitting an e-mail. The e-mail data transmitting unit 72 has a function for transmitting information by wireless using, for example, BlueTooth (registered trademark), infrared ray, or the like.

Thereafter, the user transmits the e-mail main text for program reservation to the receiving apparatus which makes program reservation registration from the information terminal to which the e-mail main text for program reservation has been transmitted. Then, in the receiving apparatus, program reservation registration is made based upon the e-mail main text for program reservation received by e-mail, so that program reservation using an e-mail function is made to the receiving apparatus.

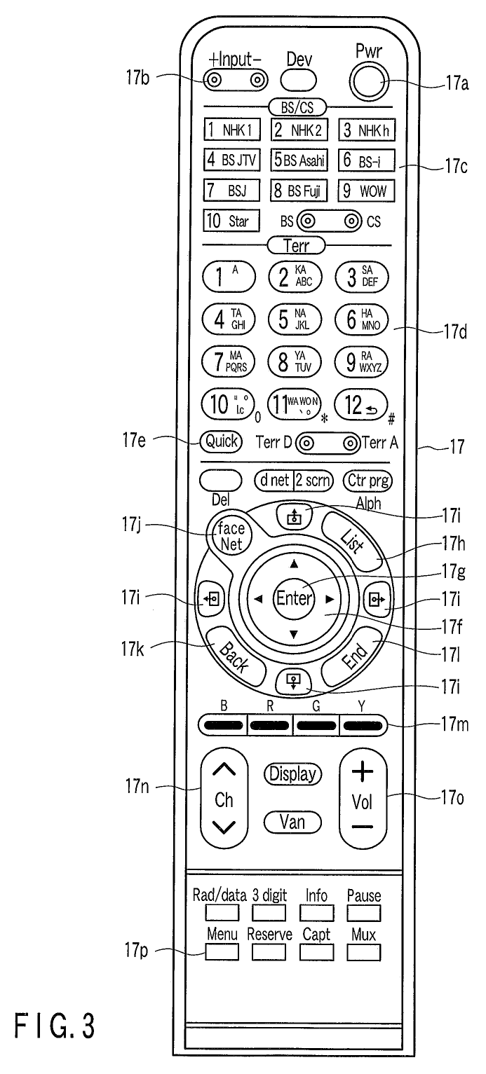

FIG. 3 shows the appearance of the remote controller 17. The remote controller 17 is mainly provided with a power key 17a, an input switching key 17b, direct selecting keys 17c of satellite digital broadcasting channels, direct selecting keys 17d of terrestrial broadcasting channels, a quick key 17e, a cursor key 17f, a enter key 17g, a program listing key 17h, a page switching key 17i, a face net (navigation) key 17j, a back key 17k, an end key 17l, blue, red, green, and yellow color keys 17m, a channel up and down key 17n, a volume adjusting key 17o, a menu key 17p, and the like.

Here, in the digital television broadcasting receiving apparatus 11, the user can display the electronic program listing on the image display device 14 by operating the program listing key 17h of the remote controller 17.

The electronic program listing is produced based upon EPG information which is program information preliminarily acquired through a broadcasting signal or a network, and in the case of television broadcasting, a listing of all programs for the next week is produced, and displayed on the image display device 14.

However, the whole electronic program listing for one week is not displayed on the image display device 14, but a fixed region comprising a predetermined number of channels and a predetermined range of time and dates is displayed on the image display device 14.

Then, the user can view a desired region in the electronic program listing by scrolling the electronic program listing on the screen of the image display device 14, or switching regions in which the electronic program listing is displayed by one screen of the image display device 14.

Incidentally, when the user operates the program listing key 17h of the remote controller 17, the region of the electronic program listing first displayed on the image display device 14 is determined based upon the last condition such as a channel or time and date displayed previously.

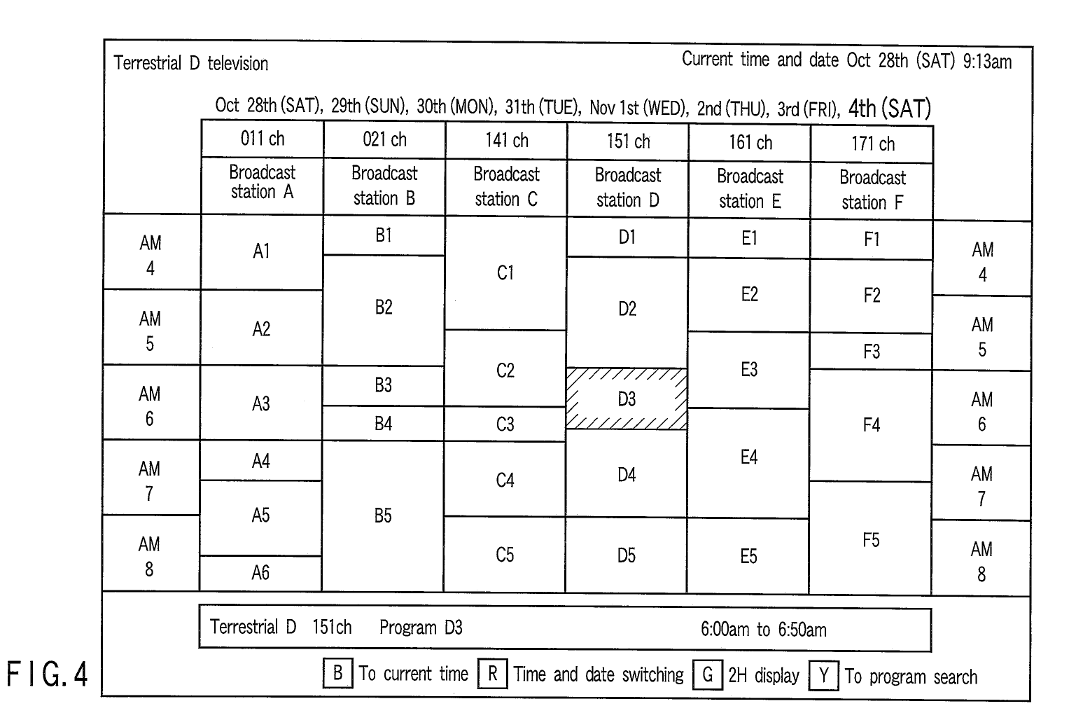

FIG. 4 shows one example of a display pattern of the electronic program listing displayed on the image display device 14. The electronic program listing displays programs, in which the horizontal direction is a channel axis for arranging a plurality (six in FIG. 4) of broadcast stations (channels), and the vertical direction is a time axis corresponding to a time range of several hours (five hours in FIG. 4).

That is, the central portion of the electronic program listing has six program columns arranged in the horizontal direction corresponding to the six broadcast stations (channels). In the six program columns, channel numbers 011, 021, 141, 151, 161, 171, broadcast station names A, B, C, D, E, F, program names A1 to A6, B1 to B5, C1 to C5, D1 to D5, E1 to E5, F1 to F5 are described, respectively.

Further, in the electronic program listing, on the upper unit in FIG. 4, a display “terrestrial D television” showing that the kind of broadcast which is currently being received is a terrestrial digital television broadcast, a display “current time and date 10/28 (SAT) AM 9:13” showing that the current time and date is Saturday October 28^{th} and the current time is 9:13 am, and a display showing a displayable range of dates (days of the week) of the electronic program listing are performed.

That is, now, the time and date is October 28^{th} (SAT) at 9:13 am, so the electronic program listing from October 28^{th} (SAT) at 9 am to Nov. 4^{th} (SAT) at 8 am (before 9 am), which is one week later, is prepared. Then, a displayable range of dates (days of the week) of the electronic program listing is eight days; consisting of dates (days) from the current date (day of the week) to this date (day of the week) week, namely, Oct 28^{th} (SAT), 29^{th} (SUN), 30^{th} (MON), 31^{th} (TUE), Nov 1^{st} (WED), 2^{nd} (THU), 3^{rd} (FRI), 4^{th} (SAT), which are arranged in sequence. In this case, a character [4 (SAT)] showing the date (day of the week) of the electronic program listing currently displayed is displayed larger than a character showing the other dates (days of the week).

Further, in the electronic program listing, on the lower unit in FIG. 4, relating to a program D3 currently selected (indicated by cursor on the electronic program listing), the kind of broadcast (terrestrial D), channel number (151 ch), program name (D3), broadcasting time (6:00 am to 6:50 am), and the like are displayed. In this case, when the program D3 currently selected is indicated by the cursor, the display region thereof in the electronic program listing is displayed with a color different from display regions of the other programs. In FIG. 4, however, this fact is expressed by hatching out the surrounding area of the display region.

Further, in the electronic program listing, on its right and left sides, from top down, a region for displaying a time range of five hours, by the hour, is provided. In FIG. 4, from top down in FIG. 4, the time range for five hours showing 4 am, 5 am, 6 am, 7 am, 8 am is displayed.

Further, in the electronic program listing, on the lower unit in FIG. 4, corresponding to the respective colors (blue, red, green, yellow) of the color keys 17m of the remote controller 17, functions to be realized when the color keys 17m of these colors are operated are displayed.

The electronic program listing can be selectively scrolled from right to left or up and down sides by operating the cursor key 17f of the remote controller 17. Further, by operating the page switching key 17i of the remote controller 17, the electronic program listing can be selectively skipped from right to left or up and down sides by one screen.

In this case, when scrolling or skipping is performed in a direction along the time axis, times displayed on the right and left sides of the electronic program listing and program names displayed in the six program columns are changed to times and program names after scrolling or skipping, respectively. Further, when scrolling or skipping is performed in a direction along the channel axis, channel numbers, broadcast station names, and program names displayed in the six program columns are changed to channel numbers, broadcast station names, and program names after scrolling or skipping, respectively.

Next, a sequence of operations, which is performed when a user selects a desired program from the electronic program listing displayed on the image display device 14 as described above, of producing automatically the e-mail main text for program reservation for making program reservation registration of the selected program by e-mail to the receiving apparatus (not shown), and sending the e-mail main text for program reservation to the receiving apparatus by e-mail from an information terminal will be explained in detail.

That is, as explained in FIG. 4, each program described in the electronic program listing displayed on the image display device 14 can be selected by the cursor. For example, when the user operates the enter key 17g of the remote controller 17 in a state in which the program D3 has been selected by the cursor, a reservation selection screen such as shown in FIG. 5 is displayed on the image display device 14.

The reservation selection screen displays, relating to the program D3 selected and determined on the electronic program listing, the kind of broadcast (terrestrial D), channel number (151 ch), broadcast date [November 4^{th} (SAT)], program name (D3), broadcast time (6:00 am to 6:50 am), and the like of the program D3 are displayed, and further displays four kinds of items; “record reservation”, “watch reservation”, “mail data conversion”, and “back”. Then, the user operates the cursor key 17f of the remote controller 17 and selects one of the four items, and can determine the selected item by operating the enter key 17g.

That is, when the item “record reservation” is selected and determined, the digital television broadcasting receiving apparatus 11 is switched to a processing for designating an external recording device connected to the terminals 21 to 24 and making record reservation registration of the program D3 selected and determined from the electrical program listing, and a screen for setting therefor is displayed.

Further, the item “watch reservation” is selected and determined, the digital television broadcasting receiving apparatus 11 is switched to a processing for designating itself or an external receiving device connected to the terminals 21 to 24 and making watch reservation registration of the program D3 selected from the electrical program listing, and a screen for setting therefor is displayed. Further, in the case the item “back” is selected and determined, the display of the previous screen is restored.

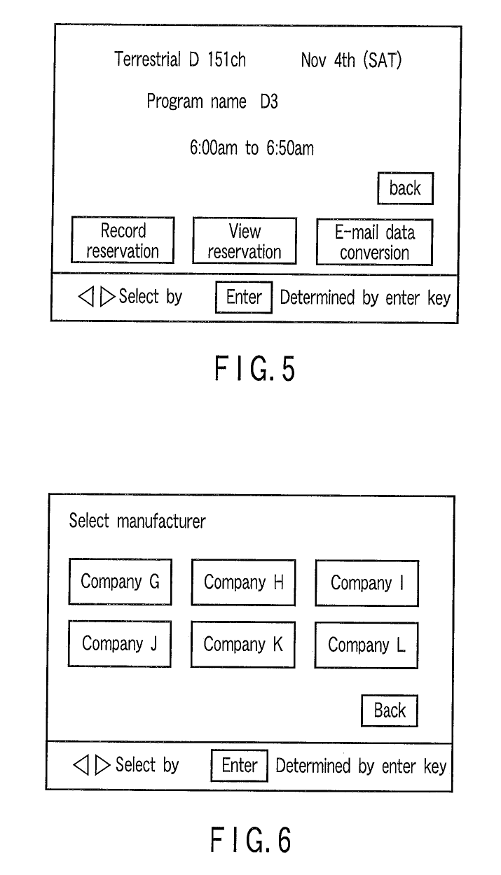

Then, when the item “mail data conversion” has been selected and determined, a maker selection screen such as shown in FIG. 6 is displayed. The maker selection screen is for designating a manufacturer of the receiving apparatus which makes program reservation registration by e-mail, six types of items showing a plurality (six in FIG. 6) of manufacturer names, “company G”, “company H”, “company I”, “company J”, “company K”, “company L”, and the item “back” are displayed.

Then, the user can operate the cursor key 17f of the remote controller 17, select an item, and determine the selected item by operation of the enter key 17g. In this case, when the item “back” is selected and determined, the display of the previous screen is restored.

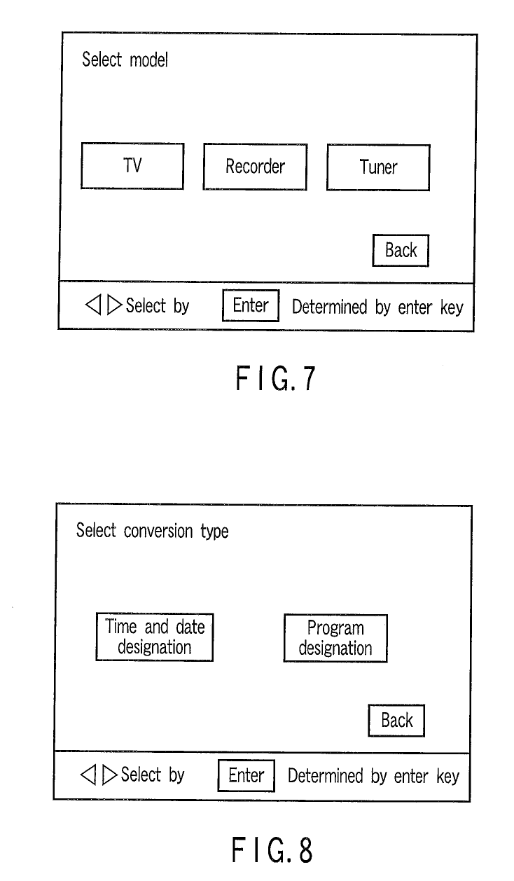

Further, when an item corresponding to the manufacturer names “company G” to “company L” is selected and determined, a model selection screen such as shown in FIG. 7 is displayed. The model selection screen is for designating a model which makes program reservation registration by e-mail, where three types of items showing “television”, “recorder”, “tuner” and the item “back” are displayed.

Then, the user can operate the cursor key 17f of the remote controller 17, select an item, and determine the selected item by operating the enter key 17g. In this case, when the item “back” is selected and determined, the display of the previous screen is restored.

Incidentally, the reason why the maker selection screen shown in FIG. 6 and the model selection screen shown in FIG. 7 are displayed in a state in which the item “mail data conversion” has been selected and determined on the record selection screen shown in FIG. 5, and then a manufacturer and a model of a receiving apparatus which makes program reservation registration by e-mail are selected and determined is because formats of the e-mail main text for program reservation differ according to manufacturer and model, even for the same manufacturer.

In the digital television broadcasting receiving apparatus 11 which has been explained in the embodiment, regarding various types of receiving apparatuses equipped with a function for making program reservation registration by e-mail, e-mail main texts for program reservations corresponding to various formats for respective manufacturers and models are prepared and stored in, for example, the nonvolatile memory 63d.

Then, in the e-mail data producing unit 63e, the e-mail main text for program reservation in a format corresponding to a manufacturer and a model which have been selected and determined on the maker selection screen and the model selection screen is read out of the nonvolatile memory 63d, and an e-mail main text for program reservation to the program which has been selected and determined from the electronic program listing is produced.

Here, once a model is selected and determined on the model selection screen shown in FIG. 7, a conversion type selection screen such as shown in FIG. 8 is displayed. The conversion type selection screen is for designating either making program reservation by designating time and date, channel, or the like, so-called time and date designating reservation, or making program reservation by designating a program itself, so-called program designating reservation, and two items showing “time and date designation” and “program designation” and the item “back” are displayed.

Then, the user can operate the cursor key 17f of the remote controller 17, select an item, and determine the selected item by operation of the enter key 17g. In this case, when the item “back” is selected and determined, the display of the previous screen is restored.

Further, when the item “time and date designation” is selected and determined on the conversion type selection screen shown in FIG. 8, the e-mail data producing unit 63e uses the e-mail main text for program reservation read out of the nonvolatile memory 63d in a format corresponding to the manufacturer and the model selected and determined on the maker selection screen and the model selection screen to produce an e-mail main text for program reservation corresponding to time and date designation with respect to the program selected and determined from the electronic program listing.

Further, when the item “program designation” is selected and determined on the conversion type selection screen shown in FIG. 8, the e-mail data producing unit 63e uses the e-mail main text for program reservation read out of the nonvolatile memory 63d in a format corresponding to the manufacturer and the model selected and determined on the maker selection screen and the model selection screen to produce an e-mail main text for program reservation corresponding to program designation with respect to the program selected and determined from the electronic program listing.

In the e-mail data producing unit 63e, program reservation information such as time and date or channel with respect to the program selected and determined from the electronic program listing is acquired from the EPG information, and this program reservation information is applied to necessary locations in the e-mail main text for program reservation read out of the nonvolatile memory 63d, which thereby produces an e-mail main text for program reservation necessary for program reservation of the program.

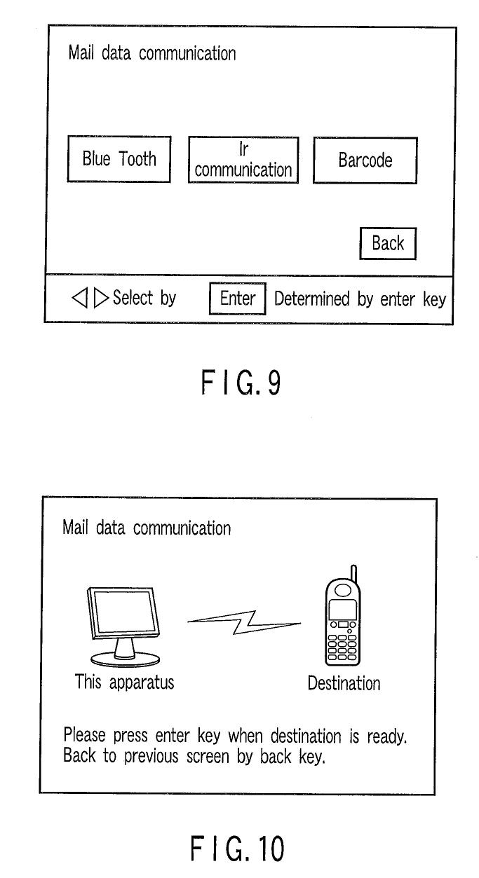

Once the item “time and date designation” or “program designation” is selected and determined on the conversion type selection screen shown in FIG. 8, and the e-mail main text for program reservation is produced at the e-mail data producing unit 63e, an e-mail data communication screen such as shown in FIG. 9 is displayed. The e-mail data communication screen is for designating means for transmitting the e-mail main text for program reservation produced at the e-mail data producing unit 63e to the information terminal (not shown) for transmitting an e-mail to the receiving apparatus which makes program reservation registration, and three items showing “BlueTooth (registered trademark)”, “Ir (infrared) communication”, “barcode”, and the item “back” are displayed.

Then, the user can operate the cursor key 17f of the remote controller 17, select an item, and determine the selected item by operation of the enter key 17g. In this case, when the item “back” has been selected and determined, the display of the previous screen is restored.

Once the item “BlueTooth (registered trademark)” or “Ir communication” is selected and determined on the e-mail data communication screen shown in FIG. 9, an e-mail data transmission screen such as shown in FIG. 10 is displayed. After the information terminal (not shown), which is a destination for transmitting an e-mail to the receiving apparatus which makes program reservation registration is caused to complete reception preparation in a state in which the e-mail data transmission screen has been displayed, the e-mail data transmitting unit 72 is directed at a receiving unit of the information terminal.

Then, when the user operates the enter key 17g of the remote controller 17, the e-mail main text for program reservation produced at the e-mail data producing unit 63e is transmitted by wireless through BlueTooth (registered trademark) or infrared from the e-mail data transmitting unit 72, and received by the receiving unit of the information terminal. Thereby, the e-mail main text for program reservation produced at the e-mail data producing unit 63e is transmitted by wireless to the information terminal.

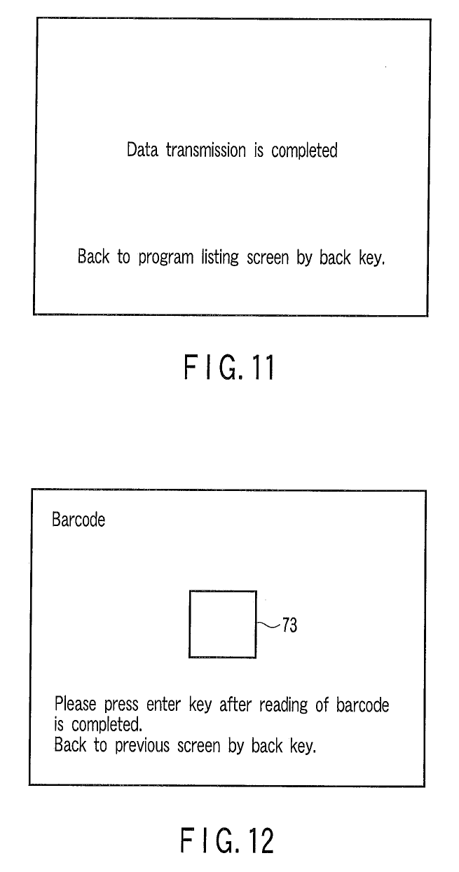

When transmission of the e-mail main text for program reservation from the e-mail data transmitting unit 72 has been completed in this manner, a data transmission completion screen such as shown in FIG. 11 is displayed, thereby, the fact that wireless transmission of the e-mail main text for program reservation produced at the e-mail data producing unit 63e to the information terminal has been completed is reported to the user. Incidentally, by operating the back key 17k of the remote controller 17 on the e-mail data transmission screen shown in FIG. 10 and the data transmission completion screen shown in FIG. 11, the display of the previous screen can be restored.

Further, when the item “barcode” is selected and determined on the e-mail data communication screen shown in FIG. 9, a barcode screen such as shown in FIG. 12 is displayed. On the barcode screen, the e-mail main text for program reservation produced at the e-mail data producing unit 63e is converted into a notation of a barcode 73 and displayed.

Then, a barcode reading unit of the information terminal which is the destination for transmitting an e-mail to the receiving apparatus which makes program reservation registration is brought close to the barcode screen displayed on the image display device 14 and caused to read the barcode 73, so that the e-mail main text for program reservation produced at the e-mail data producing unit 63e is transmitted to the information terminal. In the transmission of the e-mail main text for program reservation to the information terminal by the barcode 73, the information terminal reports completion of reading the barcode 73 to the user.

Once the e-mail main text for program reservation produced at the e-mail data producing unit 63e of the digital television broadcasting receiving apparatus 11 is transmitted to the information terminal for transmitting an e-mail to the receiving apparatus for making program reservation registration, the user transmits the e-mail main text for program reservation from the information terminal to the receiving apparatus by using the e-mail function. Then, the receiving apparatus makes program reservation registration based upon the e-mail main text for program reservation received as an e-mail, so that program reservation using the e-mail function is made to the receiving apparatus.

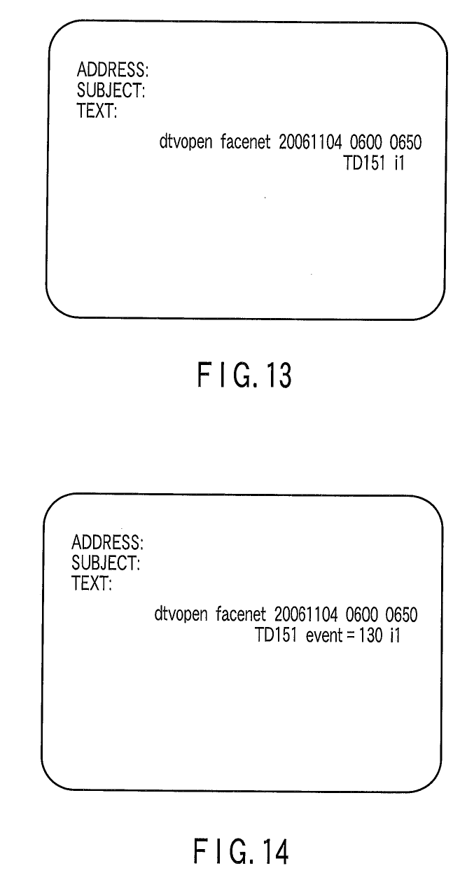

Here, FIG. 13 shows one example of the e-mail main text for program reservation displayed on a display screen of the information terminal when the e-mail main text for program reservation produced in a case in which the item “time and date designation” has been selected and determined on the conversion type selection screen shown in FIG. 8 is transmitted to the information terminal. The e-mail main text for program reservation includes the destination address of the e-mail, subject of a program to be reserved, broadcasting date, broadcasting time, channel, and further, various pieces of program reservation information showing that the reservation content is watch reservation or record reservation.

Further, FIG. 14 shows one example of the e-mail main text for program reservation displayed on a display screen of the information terminal when the e-mail main text for program reservation produced in a case in which the item “program designation” has been selected and determined on the conversion type selection screen shown in FIG. 8 is transmitted to the information terminal. The e-mail main text for program reservation includes the destination address of the e-mail, subject of a program to be reserved, broadcasting date, broadcasting time, channel, information showing that a reservation content is view reservation or record reservation, and further, various types of program reservation information showing an identification number (event=130) inherent to the program to be reserved.

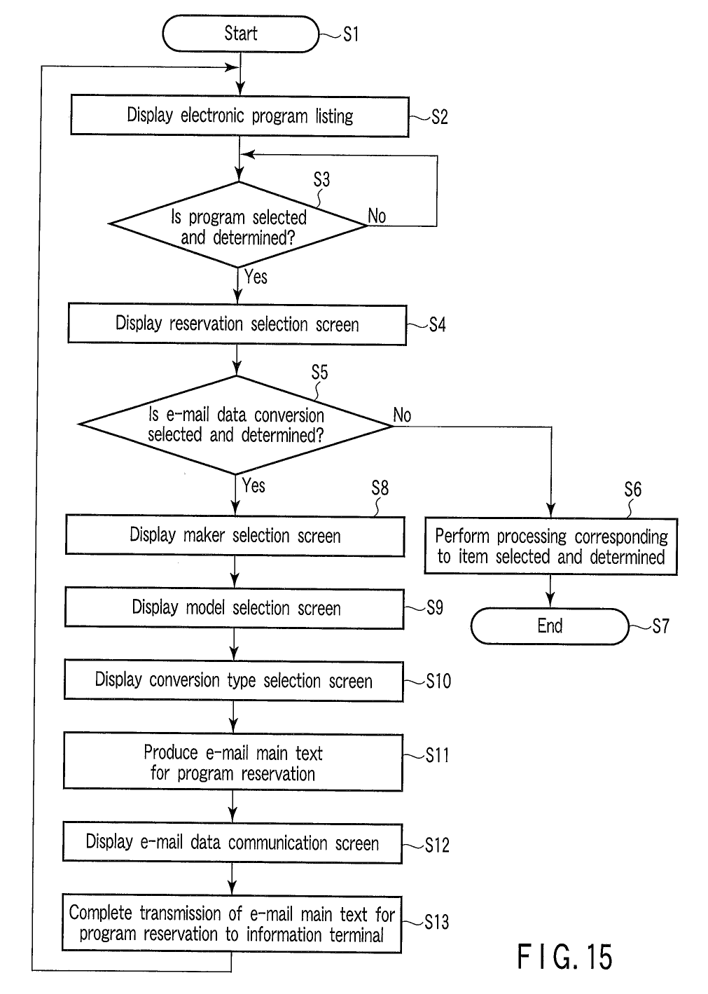

FIG. 15 shows a flowchart consisting of a series of processing operations from automatically producing the e-mail main text for program reservation with respect to the program selected by the user from the electronic program listing to transmitting the e-mail main text for program reservation from the information terminal to the receiving apparatus by e-mail.

That is, when the processing is started (step S1), and the electronic program listing is displayed on the image display device 14 at step S2, the control unit 63 determines whether a predetermined program has been selected and determined from the electronic program listing at step S3. Then, when a determination that a program has been selected and determined is made (YES), the control unit 63 displays the reservation selection screen shown in FIG. 5 with respect to a program selected and determined at step S4.

Thereafter, the control unit 63 determines whether the item “mail data conversion” has been selected and determined from the reservation selection screen at step S5. Then, when a determination that an item other than the item “mail data conversion” has been selected and determined is made at step S5 (NO), the control unit 63 controls to apply a processing corresponding to the item selected and determined at step S6, and terminates the processing (step S7).

Further, when a determination that the item “mail data conversion” has been selected and determined from the reservation selection screen is made at step S5 (YES), the control unit 63 displays the maker selection screen shown in FIG. 6 at step 8. Then, when a predetermined manufacturer is selected and determined on the maker selection screen, the control unit 63 displays the model selection screen shown in FIG. 7 at step S9.

When a predetermined model is selected and determined on the model selection screen, the control unit 63 displays the conversion type selection screen shown in FIG. 8 at step S10. Then, when “time and date designation” or “program designation” has been selected and determined on the conversion type selection screen, the control unit 63 produces the e-mail main text for program reservation at step S11, and displays the e-mail data communication screen shown in FIG. 9 at step S12. Thereafter, at step S13, the control unit 63 is returned to the processing of step S2 in a state in which transmission of the e-mail main text for program reservation to the information terminal by the means selected on the e-mail data communication screen.

According to the above embodiment, a user selects a desired program from the electronic program listing, thereby, an e-mail main text for program reservation for make program reservation registration by e-mail with respect to the selected program is automatically produced, and transmitted to an information terminal which transmits an e-mail.

Therefore, since the user is not required to perform complicated input operations for producing the e-mail main text for program reservation, and a receiving apparatus which makes program reservation registration can be caused to make program reservation using an e-mail function by simple operation, it becomes possible to make manipulation convenient for users.

Incidentally, as the user's operation, for example, a digital television broadcasting receiving apparatus 11 such as the one shown in FIG. 1 is caused to display an electronic program listing at an outside location, and when there is a program to be reserved, produce an e-mail main text for program reservation in a format corresponding to his/her home receiving apparatus, and transmit the e-mail main text for program reservation to an information terminal such as a mobile phone he/she carries. Then, the user transmits the e-mail main text for program reservation from the information terminal to his/her home receiving apparatus using e-mail. Thereby, program reservation registration is made to the receiving apparatus.

Since an e-mail main text for program reservation is created for the program selected from the electrical program listing in a format corresponding to the settings made by a user with respect to a manufacturer, a model, and the like of a receiving apparatus which makes program reservation registration, the text is practical in that it is compatible with various types of receiving apparatus.

Further, in a system of making program reservation by e-mail from an information terminal to a receiving apparatus which makes program reservation registration, information showing an identification number inherent to a program to be reserved can be included in the e-mail main text for program reservation transmitted by e-mail to the receiving apparatus from the information terminal to make program designation reservation.

Therefore, the receiving apparatus which has received the e-mail main text for program reservation can manage the reservation program based upon the identification number. Thereby, for example, even if the broadcast time of the program to be reserved is changed, the receiving apparatus can detect the fact from the EPG information acquired after the change of the broadcast time and thereafter, a program reservation function can be achieved accurately.

Further, in the above embodiment, the electronic program listing which has been produced based upon the EGP information and displayed on the image display device 14 is applied with the format shown in FIG. 4, but the electronic program listing is not limited to the format shown in FIG. 4, and it is obvious that the electronic program listing may be displayed with another format as long as broadcasted reservation programs are displayed by a list based upon the EGP information and a program to be reserved can be selected therefrom.

Further, as an information terminal for transmitting an e-mail to a receiving apparatus which makes program reservation registration, namely, an information terminal which receives an e-mail main text for program reservation produced at the e-mail data producing unit 63e and transmits the e-mail main text for program reservation by e-mail to the receiving apparatus which makes program reservation registration, for example, a mobile phone, a personal digital assistant, a PC, and the like can be used.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A program reservation apparatus comprising:
an acquiring unit configured to acquire program information,
a program listing producing unit configured to produce an electronic program listing based upon the program information acquired by the acquiring unit,
a display unit configured to display the electronic program listing produced by the program listing producing unit on a screen,
a selecting unit configured to select and determine a desired program from the electronic program listing displayed on the display unit,
an e-mail producing unit configured to produce an e-mail main text for program reservation for making program reservation by e-mail with respect to the program selected and determined by the selecting unit, and
a transmitting unit configured to transmit the e-mail main text for program reservation produced by the e-mail producing unit to the outside.

2. The program reservation apparatus according to claim 1, wherein
the e-mail producing unit is configured to be capable of producing the e-mail main texts for program reservation with formats corresponding to various receiving apparatuses capable of making program reservation registration by e-mail.

3. The program reservation apparatus according to claim 1, wherein
the e-mail producing unit
comprises a setting unit configured to set manufacturer and model of a receiving apparatus which makes program reservation registration by e-mail, and
is configured to produce an e-mail main text for program reservation in a format corresponding to a receiving apparatus for making program reservation registration by e-mail, based upon the manufacturer and the model set by the setting unit.

4. The program reservation apparatus according to claim 1, wherein
the e-mail producing unit is configured to produce an e-mail main text for program reservation for making program designation reservation with respect to the program selected and determined by the selecting unit by e-mail including identification information inherent to the program.

5. The program reservation apparatus according to claim 1, wherein
the transmitting unit is configured to transmit the e-mail main text for program reservation produced by the e-mail producing unit to an external information terminal by either wireless or barcode.

6. A broadcast receiving apparatus comprising:
a receiving unit configured to receive a broadcasting signal,
a signal processing unit configured to produce a video signal by extracting a desired channel signal from the broadcasting signal received by the receiving unit and applying a predetermined signal processing,
an outputting unit configured to output the video signal acquired by the signal processing unit,
an acquiring unit configured to acquire program information,
a program listing producing unit configured to produce an electronic program listing based upon the program information acquired by the acquiring unit,
a display unit configured to display the electronic program listing produced by the program listing producing unit on a screen,
a selecting unit configured to select and determine a desired program from the electronic program listing displayed on the display unit,
an e-mail producing unit configured to produce an e-mail main text for program reservation for making program reservation by e-mail with respect to the program selected and determined by the selecting unit, and
a transmitting unit configured to transmit the e-mail main text for program reservation produced by the e-mail producing unit to the outside.

7. A program reservation method comprising:
acquiring program information,
producing an electronic program listing based upon the program information acquired,
displaying the electronic program listing produced on a screen,
selecting and determining a desired program from the electronic program listing displayed,
producing an e-mail main text for program reservation for making program reservation by e-mail with respect to the program selected and determined, and
transmitting the e-mail main text for program reservation produced to the outside.
